(19) United States
(12) Patent Application Publication
(10) Pub. No.: US 2006/0141164 A1
(43) Pub. Date: Jun. 29, 2006

(54) Nanostructure and manufacturing method therefor

(75) Inventors: Yasuhiro Akita, Kanagawa-ken (JP); Satoshi Shimma, Aichi-ken (JP); Takahiro Seki, Aichi-ken (JP); Shusaku Nagano, Aichi-ken (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES LTD., Tokyo (JP)

(21) Appl. No.: 11/285,775

(22) Filed: Nov. 23, 2005

(30) Foreign Application Priority Data
Nov. 30, 2004 (JP) 2004-347310
Dec. 3, 2004 (JP) 2004-352086

(51) Int. Cl. B05D 1/18

(52) U.S. Cl. 427/430.1; 428/221

(57) ABSTRACT

An object is to provide a nanostructure having a two dimensionally spread homogenous nanostructure, and a method of manufacturing a nanostructure that can be performed by a low cost and simple process. Another object is to provide a nanostructure having a homogenous nanostructure in a large area, and a method of manufacturing a nanostructure that can be performed by a low cost and simple process. A monomolecular film is obtained by spreading a mixed solution containing an amphipathic block copolymer which has hydrophilic segments and hydrophobic segments, and a low molecular weight compound which is compatible with the hydrophobic segments, on the surface of water. A mixed monomolecular film is formed by spreading a mixed solution containing an amphipathic block copolymer which has hydrophilic segments and hydrophobic segments, and a low molecular weight compound which is compatible with the hydrophobic segments, on the surface of water, and then increasing the surface pressure of the mixed monomolecular film.

### BACKGROUND OF THE INVENTION

1. Field of the Invention

The present invention relates to a nanostructure using a block copolymer, and a manufacturing method therefor.

This application is based on Japanese Patent Applications Nos. 2004-347310 and 2004-352086, the contents of which are incorporated herein by reference.

2. Description of Related Art

As a method of obtaining a surface nanopattern using a block copolymer, a method which uses the surface of a spin cast film or a cast film, and a method of forming a nanopattern using a monomolecular film of a block copolymer on a water surface and then transferring the nanopattern onto a substrate or the like, are performed.

A method for obtaining a surface nanophase separation pattern by forming a so-called water surface monomolecular film by spreading a block copolymer having hydrophilic segments and hydrophobic segments (hereunder, called “amphipathic block copolymer”) on the water surface is reported in Cox et. al., Current Opinion in Colloid & Interface Science, 1999, Vol. 4, p. 52, and Meli et. al., Nano Lett., 2002, Vol. 2, p. 131, and the like, and has been conventionally performed. If a typical block copolymer thin film (film thickness: about several 100 nanometers) is used, segments having lower surface tension become manifest on the surface, inhibiting the formation of a target nanostructure on the surface. Therefore, etching is used in order to expose the nanophase separation structure on the surface. On the other hand, since a method of using a water surface monomolecular film of a block copolymer provides a nanophase separation pattern directly on the surface, it is useful in terms of omitting a complicated process such as etching.

However, in these methods that have been conventionally performed, at the time of spreading the monomolecular film on the surface of the water, the hydrophobic segments in the block copolymer are aggregated immediately on the water surface. Therefore, only a surface nanophase separation pattern having a plurality of ununiformly spread clusters or dots that are three dimensionally aggregated hydrophobic segments is obtainable. Accordingly, neither a surface nanophase separation pattern where hydrophobic segments are two dimensionally spread on the water surface, nor a homogenous surface nanophase separation pattern have been obtained.

Examples of a surface nanophase separation pattern where hydrophilic segments and hydrophobic segments are spread include a stripe structure. The stripe structure is a phase separation structure which is expected to be applicable to nanowires and the like. As a conventional method of forming such a stripe structure, there are known: a method of casting a block copolymer in a groove having a width of several microns and a height of several tens of nanometers formed by using photolithography, or on a hydrophilic and hydrophobic pattern having a width of several microns, so that the film thickness becomes several tens of nanometers, and then subjecting to heat treatment (Kim et. al., Nature, 2003, Vol. 424, p. 411, and Sundrani et. al., Nano Lett., Vol. 4, p.

273); and a method of making a film by melting a compound that is an organic crystal at room temperature, with a high temperature, and pressing with a block copolymer thin film of several tens of nanometers, and melting and then cooling to room temperature, to thereby form a stripe shaped film on a microorder organic crystal domain (Rosa et. al., Nature, 2000, Vol. 405, p. 433).

However, such conventional methods have not been capable of obtaining a nanophase separation pattern having a stripe structure, without separately performing the abovementioned process such as photolithography or etching. Photolithography is a complicated process and expensive. Moreover, although it is applicable when forming a pattern in a relatively small area, it is inapplicable when forming a homogenous pattern in a large area of, for example about several square centimeters. Consequently, a method has been desired in which a nanostructure having a two dimensionally spread homogenous nanostructure in a large area can be manufactured by a low cost process.

On the other hand, in the water surface monomolecular film, in a case where the proportion of hydrophobic segments in the amphipathic block copolymer is relatively low, or where the segment ratio of hydrophobic segments to hydrophilic segments is within a preferable range, an area in which a dot array shaped nanophase separation pattern is obtained, may appear. Even in such a case, the current state is still that the nonuniformity occurs in intervals between the dots, and in the dot/strip shape, and the size of dot aggregations and the intervals therebetween largely vary from place to place. Furthermore, the preferable range of the segment ratio is narrow, and it has been impossible to control the dot size and the interval by means of polymers having different segment ratios. For such reasons, it has been extremely difficult to obtain a dot shaped surface nanophase separation pattern which is homogenous in a large area of several tens of square microns or more.

As a conventional method of forming a uniform dot array shaped surface nanophase separation pattern, there is known a method of using photolithography (Asakawa et. al., J. Photopolym. Sci. Technol., 2002, Vol. 15, p. 465, and the like) although it is complicated and expensive.

However, the abovementioned conventional method of obtaining a surface nanopattern using a block copolymer has following problems:

(1) in the case of a cast film or spin cast film, only hydrophobic segments are exposed on the gas interface, and hence etching is required to obtain the expected nanophase separation surface;

(2) a three dimensional bulk film, or a thin film on a substrate have poor fluidity, and hence annealing for a long time at high temperature in the vicinity of the melting point is essential to obtain a uniform nanophase separation structure, thus making it difficult to obtain a large area of a smooth surface due to film distortion or crawling caused by heating;

(3) in the case of using a water surface monomolecular film, hydrophobic segments are aggregated immediately after the block copolymer is spread on the water surface, and hence the nanophase separation structure is ununiform (this phenomena is remarkable particularly in an area of 5 μm² or more);

(4) a process using photolithography is required to obtain a regular phase separation structure.

Therefore, it has been extremely difficult in the conventional methods to obtain a homogenous surface nanophase separation pattern, without separately performing a process such as photolithography or etching. Moreover, although photolithography is applicable when forming a pattern in a relatively small area, it is unsuitable in principle when forming a large pattern, and is thus inapplicable. These methods are complicated and expensive, and a method has been desired whereby a nanostructure having a homogenous nanostructure in a large area, can be manufactured by a low cost process.

### BRIEF SUMMARY OF THE INVENTION

The present invention takes such problems into account with an object of providing a nanostructure having a two dimensionally spread homogenous nanostructure, and a nanostructure having a homogenous nanostructure in a large area. Moreover, another object of the present invention is to provide a method of manufacturing a nanostructure that can be performed by a low cost and simple process.

In order to solve the above problems, the present invention employs the following solutions.

That is, a first aspect of the present invention is a nanostructure comprising a mixed monomolecular film, containing an amphipathic block copolymer which has hydrophilic segments and hydrophobic segments, and a low molecular weight compound which is compatible with the hydrophobic segments.

In the nanostructure of the first aspect of the present invention, since the hydrophobic segments are compatible with the low molecular weight compound, it becomes a monomolecular film having a nanostructure, where the hydrophobic segments are not three dimensionally aggregated, but are two dimensionally spread.

In the nanostructure of the first aspect of the present invention, regions having the hydrophilic segments continued in the direction of the mixed monomolecular film surface, and regions having the hydrophobic segments continued in the direction of the mixed monomolecular film surface, are regularly arranged in the direction of the mixed monomolecular film surface.

Consequently, the nanostructure of the first aspect of the present invention may be used as a highly regular nanostructure as it is, or may be used as a mold for forming another highly regular nanostructure.

The regions having the hydrophilic segments continued in the direction of the mixed monomolecular film surface, and the regions having the hydrophobic segments continued in the direction of the mixed monomolecular film surface, are for example alternately arranged to form a stripe structure.

A second aspect of the present invention is a method of manufacturing a nanostructure comprising a step of spreading a mixed solution containing an amphipathic block copolymer which has hydrophilic segments and hydrophobic segments, and a low molecular weight compound which is compatible with the hydrophobic segments, on the surface of water.

According to the second aspect of the present invention, since the hydrophobic segments are compatible with the low molecular weight compound, the mixed solution can be spread in a state where the hydrophobic segments are not three dimensionally aggregated, but are two dimensionally spread, and a monomolecular film having the nanostructure in that state can be formed.

According to the first aspect and the second aspect of the present invention, using an amphipathic block copolymer, a nanostructure having a homogenous nanostructure comprising a monomolecular film in which hydrophobic segments are two dimensionally spread, can be obtained by a low cost and simple process.

Moreover, the second aspect of the present invention is the nanostructure of the first aspect, wherein the hydrophilic segments or the hydrophobic segments or both are aggregated, to form a plurality of aggregation parts.

In the nanostructure of a third aspect of the present invention, the hydrophobic segments are compatible with the low molecular weight compound. Therefore, when the mixed monomolecular film is spread on the water surface during the manufacturing process, the hydrophobic segments are not irregularly and three dimensionally aggregated but are two dimensionally spread. Then, the increase in the surface pressure of the mixed monomolecular film brings the collapse of the state where the hydrophilic segments or the hydrophobic segments or both are two dimensionally spread, and the segments become three dimensionally aggregated in the directions of the surface and thickness of the mixed monomolecular film, forming a plurality of aggregation parts. These plurality of aggregation parts form a nanopattern where various shapes are regularly arranged, by changing the conditions such as the surface pressure of the mixed monomolecular film.

Since this nanostructure can be formed without performing processes such as photolithography or etching, it can be formed in a large area (for example, 10 μm² or more).

In the nanostructure of the third aspect of the present invention, the aggregation parts are formed such that the hydrophilic segments or the hydrophobic segments or both are three dimensionally aggregated in the directions of the surface and the thickness of the mixed monomolecular film.

Since the nanostructure is one where the aggregation parts are three dimensionally formed, observation by an atomic force microscope is easy, and a clearer image is obtained. Moreover, since the pattern of the aggregation parts is thick, it can be suitably used for a mold, a plate for microcontact printing, or the like.

In the nanostructure of the third aspect of the present invention, the plurality of aggregation parts are regularly arranged in the direction of the mixed monomolecular film surface.

Consequently, the nanostructure of the third aspect of the present invention can be used as a highly regular nanostructure as it is, or can be used as a mold for forming another highly regular nanostructure.

The aggregation part is for example dot shaped.

A fourth aspect of the present invention is a method of manufacturing a nanostructure comprising: a step of forming a mixed monomolecular film by spreading a mixed solution containing an amphipathic block copolymer which has hydrophilic segments and hydrophobic segments, and a low molecular weight compound which is compatible with the hydrophobic segments, on the surface of water;

and a step of increasing the surface pressure of the mixed monomolecular film.

According to the fourth aspect of the present invention, since the hydrophobic segments are compatible with the low molecular weight compound, in the step of spreading the mixed solution, the state of the monomolecular film becomes such that the hydrophobic segments are not three dimensionally aggregated immediately but are two dimensionally spread uniformly. By increasing the surface pressure of the monomolecular film in this uniform state, the hydrophilic segments or the hydrophobic segments are three dimensionally collapsed and aggregated, and hence a homogenous surface nanostructure in a large area, where the aggregation parts are regularly arranged in the direction of the monomolecular film surface, can be obtained.

According to the third aspect and the fourth aspect of the present invention, by using an amphipathic block copolymer, a nanostructure having a homogenous nanostructure in a large area (for example, 10 μm² or more) where the hydrophilic segments or the hydrophobic segments or both are aggregated, can be obtained by a low cost and simple process.

### BRIEF DESCRIPTION OF THE SEVERAL VIEWS OF THE DRAWINGS

FIG. 1 is an atomic force microphotograph of a monomolecular film of an example 1.

FIG. 2 is an atomic force microphotograph of a monomolecular film of an example 2.

FIG. 3 is an atomic force microphotograph of a monomolecular film of an example 3.

FIG. 4 is an atomic force microphotograph of a monomolecular film of an example 4.

FIG. 5 is an atomic force microphotograph of a monomolecular film of an example 5.

FIG. 6 is an atomic force microphotograph of a monomolecular film of an example 6.

FIG. 7 is an atomic force microphotograph of a monomolecular film of an example 7.

FIG. 8 is an atomic force microphotograph of a monomolecular film of an example 8.

FIG. 9 is an atomic force microphotograph of a monomolecular film of an example 9.

FIG. 10 is an atomic force microphotograph of a monomolecular film of an example 10.

FIG. 11 is an atomic force microphotograph of a monomolecular film of an example 11.

FIG. 12 is an atomic force microphotograph of a monomolecular film of an example 12.

FIG. 13 is an atomic force microphotograph of a monomolecular film of an example 13.

FIG. 14 is an atomic force microphotograph of a monomolecular film of an example 14.

FIG. 15 is an atomic force microphotograph of a monomolecular film of a comparative example 1.

FIG. 16 is an atomic force microphotograph of a monomolecular film of a comparative example 2.

FIG. 17 is an atomic force microphotograph of a monomolecular film of a comparative example 3.

FIG. 18 is an atomic force microphotograph of a monomolecular film of a comparative example 4.

FIG. 19 is an atomic force microphotograph of a monomolecular film of a comparative example 5.

FIG. 20 is an atomic force microphotograph of a monomolecular film of a comparative example 6.

### DETAILED DESCRIPTION OF THE INVENTION

Hereunder is a description of embodiments according to a nanostructure of the present invention, and a manufacturing method therefor.

The nanostructure of the present invention is a monomolecular film having a regularity at the level of nanometer order in the direction of the film surface.

The nanostructure in the first aspect and second aspect of the present invention is mainly a stripe structure in which regions comprising hydrophilic segments and regions comprising hydrophobic segments of an amphipathic block copolymer are alternatively arranged at the level of nanometer order in the direction of a monomolecular film surface. However, the nanostructure in the first aspect and second aspect of the present invention is not limited to this, and also includes structures where hexagonal shapes, dot shapes, disk shape, or lamellar shapes at the level of nanometer order are regularly arranged in the direction of the monomolecular film surface.

Moreover, the nanostructure in the third aspect and fourth aspect of the present invention is mainly a structure in which a plurality of aggregation parts (dots) formed by the aggregation of hydrophilic segments or hydrophobic segments or both in an amphipathic block copolymer, are regularly arranged in the direction of a monomolecular film surface. However, the nanostructure in the third aspect and fourth aspect of the present invention is not limited to this, and may be a structure where the aggregation parts are formed in a linear shape, and are regularly arranged at the level of nanometer order.

The regular arrangement of dots is not specifically limited, but is normally a hexagonal arrangement with nanometer order grid length (lattice point in a diamond lattice).

The monomolecular film in the present invention is a film configured by including an amphipathic block copolymer and a low molecular weight compound. In the present application, such a film is called “monomolecular film”.

The block number of the amphipathic block copolymer is not specifically limited, however from ease of synthesizing, diblock or triblock are preferred. The ratio of hydrophilic segments to hydrophobic segments is preferably between 3/7 and 7/3 in terms of the ratio of the element numbers constituting respective main chains of the polymers of the hydrophilic segment and the hydrophobic segment. If it is not more than 3/7, or not less than 7/3, a nanophase separation structure is not formed to a clearly observable degree. The “element number constituting a main chain” is the number of elements of a main chain assuming that the main chain is the shortest route of the chain in repetitive units of polymers constituting a segment.

The hydrophobic segment is not specifically limited, however this is preferably a high molecular weight hydrophobic segment having no hydrophilic substituent in a monomer unit constituting the segment, and containing two oxygen elements or less, more preferably a high molecular weight hydrophobic segment having polydienes, polystyrenes, and an alkyl side chain. Specific examples thereof include the following high molecular weight segments:

(1) polystyrene, polymethylstyrene, poly-α-methylstyrene, polypropylene, or polyisoprene, preferably the poly(alkenes) and poly(styrenes);

(2) a n conjugated high molecule having an alkyl side chain, or a group 14 element high molecule having an alkyl side chain such as polysilane and polygermane.

The stereoregularity of these hydrophobic segments is not particularly important. The hydrophilic substituent mentioned here includes a ketone group, an ester group, an aldehyde group, an alcohol group, a phenol group, an amine group, an amide group, a sulfuric ester group, and a sulfonic group.

The hydrophilic segment preferably comprises a water soluble high molecule such as poly(4-vinylpyridine), poly(N-isopropylacrylamide), poly(2-vinylpyridine), and polyethylene glycol.

The low molecular weight compound that is used together with the amphipathic block copolymer is sufficiently compatible with the hydrophobic segment on the water surface. The low molecular weight compound is preferably an amphipathic low molecular weight compound, and more preferably one that forms a stable water surface monomolecular film. Specifically preferred is an amphipathic low molecular weight compound having an alkyl group on the hydrophobic group, in particular the compounds represented by any one of the following chemical formulae (1) to (4). 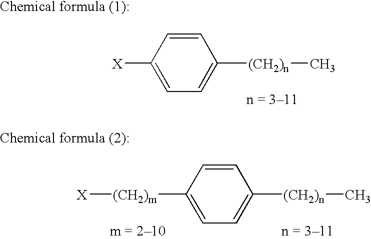 X-Q-(CH₂)ₙ—CH₃ Chemical formula (3):

n=3-11
X—(CH₂)ₘ-Q-(CH₂)ₙ—CH₃ Chemical formula (4):

m=2-10 n=3-11

In the chemical formulae (1) to (4), X represents a hydrophilic group that is necessary to form a monomolecular film on the water surface. X is preferably a cyano group, a methoxy group, or a methylester group. Q may be any mesogenic group in conventional liquid crystal compounds, and its structure is not limited. However, Q is preferably a mesogenic group selected from biphenyl, biphenylether, benzoic acid phenylester, stilbene, azoxybenzene, azobenzene, cyclohexylbenzene, cyclohexylphenylether, and cyclohexylcarboxylic acid phenylester. If Q is benzoic acid phenylester or cyclohexylcarboxylic acid phenylester, X may be a hydrogen (H).

The mixture ratio of low molecular weight compounds to amphipathic block copolymers is preferably not less than 0.05/A but not more than 0.3/A, with respect to one of the atoms constituting the main chain of the hydrophobic segments included in the amphipathic block copolymer (assuming that the main chain is the shortest route of chain in repetitive units of polymers constituting a segment), where the occupied area A per one molecule is calculated from the increased pressure shown by the low molecular weight compound as a monomolecular film. If the mixture ratio is 0.05/A or less, the amount is not sufficient with respect to the hydrophobic segments, and hence the hydrophobic segments can not be two dimensionally spread over the water surface. Moreover, if mixture ratio is 0.3/A or more, the block copolymer and the low molecular weight compound are phase-separated, and become a macro phase separation structure.

The nanostructure in the first aspect and second aspect of the present invention is formed as a mixed monomolecular film containing the aforementioned amphipathic block copolymer and the low molecular weight compound that shows an excellent compatibility with the hydrophobic segment in the amphipathic block copolymer. Typically, a mixed monomolecular film having the nanophase separation structure can be readily obtained by spreading the mixed solution made by optionally mixing the amphipathic block copolymer and the low molecular weight compound, on the water surface.

Furthermore, the nanostructure in the third aspect and fourth aspect of the present invention can be obtained by spreading on the water surface, the mixed solution containing the aforementioned amphipathic block copolymer and the low molecular weight compound that shows an excellent compatibility with the hydrophobic segment in the amphipathic block copolymer, to form a mixed monomolecular film, and then increasing the surface pressure of the mixed monomolecular film.

The mixed solution is prepared by dissolving the amphipathic block copolymer and the low molecular weight compound in a solvent. The solvent may be any solvent or any mixed solvent made of a plurality types of solvents, as long as the two compounds can be dissolved thereinto, and is not specifically limited. However, solvents which are normally used in the Langmuir-Blodgett technique (LB technique) may be employed. Specifically, a solvent made of one type of solvent or a mixed solvent made of a plurality of types of solvents selected from chloroform, tetrahydrofuran, dioxane, hexane, cyclohexane, octane, isooctane, cyclohexanone, dioxane, toluene, benzene, xylene, chlorobenzene, dichlorobenzene, dichloromethane, methanol, ethanol, propanol, butanol, ethyl acetate, γ-butyllactone, N-methylpyrrolidone, and water may be preferably used.

For the method of spreading the mixed solution on the water surface, a spreading method that is normally performed in the LB technique may be employed.

Moreover, after spreading the mixed solution on the water surface, it is preferable to extend and contract the mixed monomolecular film on the water surface in the same direction so as to fluctuate the surface pressure, since this enables formation of a more regular nanopattern.

In the third aspect and the fourth aspect, by increasing the surface pressure of the mixed monomolecular film formed in this manner, segments having low collapse pressure are three dimensionally collapsed and aggregated, forming the nanopattern. For the method of increasing the surface pressure, a method that is normally performed in the LB technique may be employed.

By transferring the monomolecular film having the nanopattern that has been formed in this manner onto the substrate, the nanopattern can be formed on the surface of the substrate. For the method of transferring the monomolecular film onto the substrate, a transferring method that is normally performed in the LB technique may be employed. For the substrate, a base material comprising one or more types of materials selected from metals, ceramics, glass, quartz, and plastics, can be used.

Hereunder is a more detailed description of the present invention with reference to examples and comparative examples, however the present invention is not limited to these and may be optionally modified within the scope of the claims of the present application.

### EXAMPLES

### Example 1

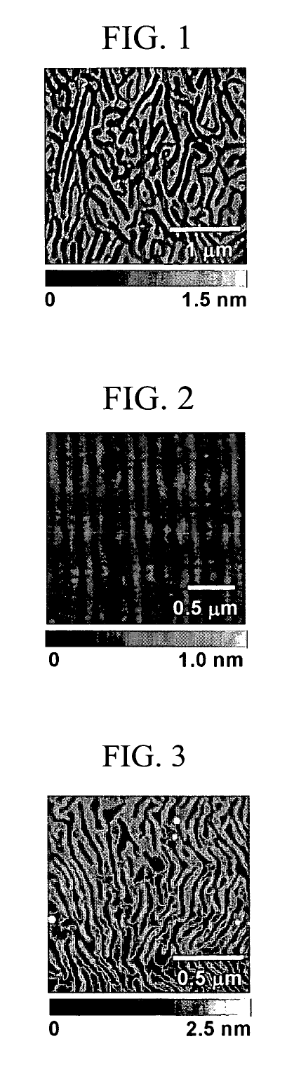

A chloroform solution was prepared using a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), with 6-[4-(4-hexylphenyl)phenoxy]hexynoic acid as a low molecular weight compound showing an occupied area per molecule of 0.4 nm², at a mixture ratio of the lower molecular weight compound of 0.44 with respect to one carbon atom of the polystyrene main chain, and the solution was spread over the water surface. The film was then transferred from the water surface onto a silicon wafer substrate by the vertical pull method at a surface pressure of 1 mN·m⁻¹ to obtain a nanostructure using the block copolymer. Film Balance FW-1 made by LAUDA corporation was used for spreading on the water surface and transferring onto the substrate. FIG. 1 shows the observation result of the nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 2

By a similar operation to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=177, 4-vinylpyridine unit=77), was used with 6-[4-(4-hexylphenylazo)phenoxy]hexynoic acid as a low molecular weight compound showing an occupied area per molecule of 0.4 nm², and these were spread over the water surface at a mixture ratio of the low molecular weight compound of 0.44 with respect to one carbon atom of the polystyrene main chain. The film was then transferred onto a silicon wafer substrate at a surface pressure of 1 mN·m⁻¹ to obtain a nanostructure using the block copolymer. FIG. 2 shows the observation result of the nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 3

By a similar operation to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), was used with 6-(4-dodecylphenoxy)hexynoic acid as a low molecular weight compound showing an occupied area per molecule of 0.5 nm², and these were spread over the water surface at a mixture ratio of the low molecular weight compound of 0.3 with respect to one carbon atom of the polystyrene main chain. The film was then transferred onto a silicon wafer substrate at a surface pressure of 1 mN·m⁻¹ to obtain a nanostructure using the block copolymer. FIG. 3 shows the observation result of the nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 4

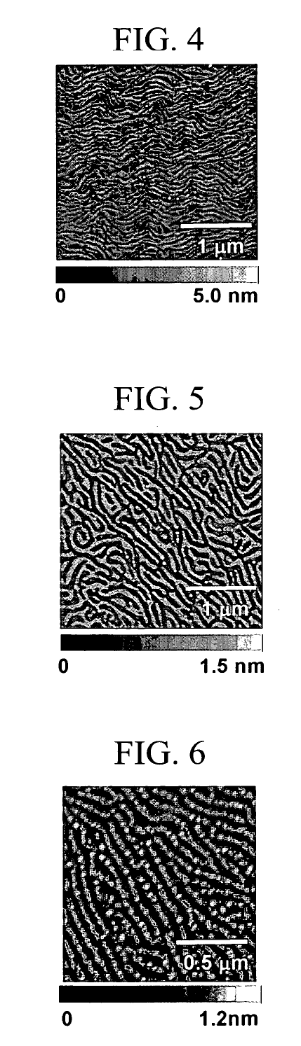

By a similar operation to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), was used with 4-dodecylcyanobenzene as a low molecular weight compound showing an occupied area per molecule of 0.5 nm², and these were spread over the water surface at a mixture ratio of the low molecular weight compound of 0.3 with respect to one carbon atom of the polystyrene main chain. The film was then transferred onto a silicon wafer substrate at a surface pressure of 1 mN·m⁻¹ to obtain a nanostructure using the block copolymer. FIG. 4 shows the observation result of the nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 5

Using a similar procedure to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), was used with 4-(4′-n-pentylbiphenylyl)benzonitrile as a low molecular weight compound showing an occupied area per molecule of 0.35 nm², and these were spread over the water surface at a mixture ratio of the low molecular weight compound of 0.5 with respect to one carbon atom of the polystyrene main chain. The film was then transferred onto a silicon wafer substrate at a surface pressure of 1 mN·m⁻¹ to obtain a nanostructure using the block copolymer. FIG. 5 shows the observation result of the nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 6

Using a similar procedure to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=177, 4-vinylpyridine unit=77), was used with 6-[4-(4-hexylphenyl)phenoxy]hexynoic acid as a low molecular weight compound showing an occupied area per molecule of 0.4 nm², and these were spread over the water surface at a mixture ratio of the low molecular weight compound of 0.09 with respect to one carbon atom of the polystyrene main chain. The film was then transferred onto a silicon wafer substrate at a surface pressure of 1 mN·m⁻¹ to obtain a nanostructure using the block copolymer. FIG. 6 shows the observation result of the block nanostructure by an atomic force microscope (SPI-3800N system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 7

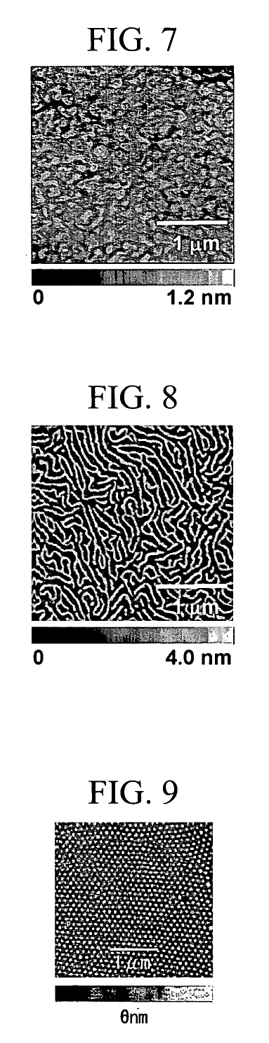

Using a similar procedure to example 1, a block copolymer having hydrophilic-hydrophobic segments showing an ununiform dot/cluster shaped nanostructure in a single monomolecular film, that is poly(styrene)-b-poly(4-vinylpyridine) (styrene unit=187, 4-vinylpyridine unit=271), was used with 6-[4-(4-hexylphenyl)phenoxy]hexynoic acid as a low molecular weight compound showing an occupied area per molecule of 0.4 nm², and these were spread over the water surface at a mixture ratio of the low molecular weight compound of 0.5 with respect to one carbon atom of the polystyrene main chain. The film was then transferred onto a silicon wafer substrate at a surface pressure of 1 mN·m⁻¹ to obtain a nanostructure using the block copolymer. FIG. 7 shows the observation result of the block nanostructure by an atomic force microscope (SPI-3800N system made by Seiko Instruments Inc.). Totally unlike the monomolecular film of a single block copolymer, the obtained nanostructure was such that regions comprising hydrophobic segments were two dimensionally spread.

### Example 8

Using a similar procedure to example 1, a block copolymer having hydrophilic-hydrophobic segments showing an ununiform dot/cluster shaped nanostructure in a single monomolecular film, that is poly(2,7-(di-n-octylfluorene))-b-poly(ethylene oxide) (fluorene unit=10, ethylene oxide unit=90) was synthesized according to the document (Macromolecules, 32, 8685 (1999)). The product was then spread together with 4′-pentyl-4-cyanobiphenyl as a low molecular weight compound showing an occupied area per molecule of 0.45 nm² over the water surface at a mixture ratio of the low molecular weight compound of 0.4 with respect to one carbon atom of the fluorene main chain. The film was then transferred onto a silicon wafer substrate at a surface pressure of 3 mN-m⁻¹ to obtain a nanostructure using the block copolymer. FIG. 8 shows the observation result of the block nanostructure by an atomic force microscope (SPI-3700 system made by Seiko Instruments Inc.). Totally unlike the monomolecular film of a single block copolymer, the obtained nanostructure was stripe shaped with regions comprising hydrophilic segments and regions comprising hydrophobic segments alternatively arranged in the direction of the monomolecular film surface.

### Example 9

A chloroform solution was prepared using a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), with 4′-pentyl-4-cyanobiphenyl as a low molecular weight compound showing an occupied area per molecule of 0.45 nm², at a mixture ratio of the low molecular weight compound of 0.44 with respect to one carbon atom of the polystyrene main chain, and this solution was then spread over the water surface. The film was then transferred onto a silicon wafer substrate by the vertical pull method at a surface pressure of 5 mN·m⁻¹ to obtain a nanostructure using the block copolymer. Film Balance FW-1 made by LAUDA corporation was used for spreading on the water surface and transferring onto the substrate. FIG. 9 shows the observation result of the nanostructure by an atomic force microscope (SPI-3700 system made by Seiko Instruments Inc.). Totally unlike the monomolecular film of a single block copolymer, the obtained nanostructure had a more uniform dot pattern.

### Example 10

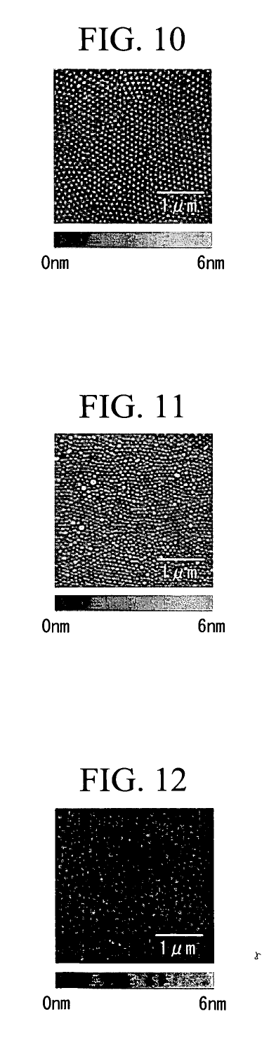

Using a similar procedure to example 9, a block copolymer having hydrophilic-hydrophobic segments showing an ununiform dot/cluster shaped nanostructure in a single monomolecular film, that is poly(styrene)-b-poly(4-vinylpyridine) (styrene unit=191, 4-vinylpyridine unit=153), was used with a low molecular weight compound represented by chemical formula (5) showing an occupied area per molecule of 0.5 nm², and these were spread over the water surface at a mixture ratio of the low molecular weight compound of 0.4 with respect to one carbon atom of the polystyrene main chain. The film was then transferred onto a silicon wafer substrate at a surface pressure of 5 mN·m⁻¹ to obtain a nanostructure using the block copolymer. FIG. 10 shows the observation result of the block nanostructure by an atomic force microscope. The obtained nanostructure had a more uniform dot pattern.

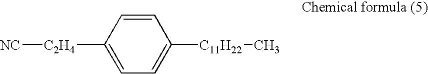

### Example 11

Using a similar procedure to example 9, a block copolymer having hydrophilic-hydrophobic segments showing an ununiform dot/cluster shaped nanostructure in a single monomolecular film, that is poly(styrene)-b-poly(4-vinylpyridine) (styrene unit=177, 4-vinylpyridine unit=77), was used with 4′-pentyl-4-cyanobiphenyl as a low molecular weight compound showing an occupied area per molecule of 0.45 nm², and these were spread over the water surface at a mixture ratio of the low molecular weight compound of 0.2 with respect to one carbon atom of the polystyrene main chain. The film was then transferred onto a silicon wafer substrate at a surface pressure of 5 mN·m⁻¹ to obtain a nanostructure using the block copolymer. FIG. 11 shows the observation result of the block nanostructure by an atomic force microscope. The obtained nanostructure had a more uniform dot pattern.

### Example 12

Using a similar procedure to example 9, a block copolymer having hydrophilic-hydrophobic segments showing an ununiform dot/cluster shaped nanostructure in a single monomolecular film, that is poly(styrene)-b-poly(4-vinylpyridine) (styrene unit=187, 4-vinylpyridine unit=271), was used with 4′-pentyl-4-cyanobiphenyl as a low molecular weight compound showing an occupied area per molecule of 0.45 nm², and these were spread over the water surface at a mixture ratio of the low molecular weight compound of 0.4 with respect to one carbon atom of the polystyrene main chain. The film was then transferred onto a silicon wafer substrate at a surface pressure of 5 mN·m⁻¹ to obtain a nanostructure using the block copolymer. FIG. 12 shows the observation result of the block nanostructure by an atomic force microscope. The obtained nanostructure had a more uniform dot pattern.

### Example 13

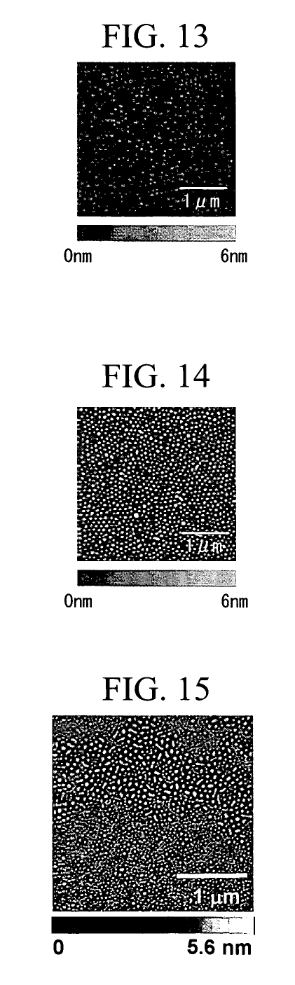

Using a similar procedure to example 9, a block copolymer having hydrophilic-hydrophobic segments showing an ununiform dot/cluster shaped nanostructure in a single monomolecular film, that is poly(α-styrene)-b-poly(ethylene oxide) (styrene unit=190, ethylene oxide unit=105), was used with 4′-pentyl-4-cyanobiphenyl as a low molecular weight compound showing an occupied area per molecule of 0.45 nm², and these were spread over the water surface at a mixture ratio of the low molecular weight compound of 0.4 with respect to one carbon atom of the polystyrene main chain. The film was then transferred onto a silicon wafer substrate at a surface pressure of 5 mN·m⁻¹ to obtain a nanostructure using the block copolymer. FIG. 13 shows the observation result of the block nanostructure by an atomic force microscope. The obtained nanostructure had a more uniform dot pattern.

### Example 14

Using a similar operation to example 9, a block copolymer having hydrophilic-hydrophobic segments showing an ununiform dot/cluster shaped nanostructure in a single monomolecular film, that is poly(propylene)-b-poly(ethylene oxide) (propylene unit=202, ethylene oxide unit=105), was used with 4′-pentyl-4-cyanobiphenyl as a low molecular weight compound showing an occupied area per molecule of 0.45 nm², and these were spread over the water surface at a mixture ratio of the low molecular weight compound of 0.4 with respect to one carbon atom of the polystyrene main chain. The film was then transferred onto a silicon wafer substrate at a surface pressure of 5 mN·m⁻¹ to obtain a nanostructure using the block copolymer. FIG. 14 shows the observation result of the block nanostructure by an atomic force microscope. The obtained nanostructure had a more uniform dot pattern.

### Comparative Example 1

FIG. 15 shows the observation result by an atomic force microscope (SPI-3700 system made by Seiko Instruments Inc.) of a nanostructure made by spreading a single block copolymer having hydrophilic-hydrophobic segments, that is poly(styrene)-b-poly(4-vinylpyridine) (styrene unit=191, 4-vinylpyridine unit=153), used in examples 1, 3, 4, 9, and 10, on the water surface.

### Comparative Example 2

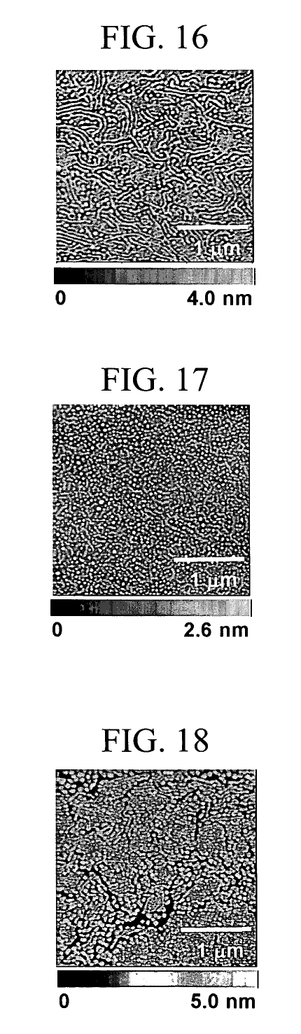

FIG. 16 shows the observation result by an atomic force microscope (SPI-3800N system made by Seiko Instruments Inc.) of a nanostructure made by spreading a single block copolymer having hydrophilic-hydrophobic segments, that is poly(styrene)-b-poly(4-vinylpyridine) (styrene unit=177, 4-vinylpyridine unit=77), used in examples 2, 6, and 11, on the water surface.

### Comparative Example 3

FIG. 17 shows the observation result by an atomic force microscope (SPI-3800N system made by Seiko Instruments Inc.) of a nanostructure made by spreading a single block copolymer having hydrophilic-hydrophobic segments, that is poly(styrene)-b-poly(4-vinylpyridine) (styrene unit=187, 4-vinylpyridine unit=271), used in examples 7 and 12, on the water surface.

### Comparative Example 4

FIG. 18 shows the observation result by an atomic force microscope (SPI-3800N system made by Seiko Instruments Inc.) of a nanostructure made by spreading a single block copolymer having hydrophilic-hydrophobic segments, that is poly(2,7-(di-n-octylfluorene))-b-poly(ethylene oxide) (fluorene unit=10, ethylene oxide unit=90), used in example 8, on the water surface.

### Comparative Example 5

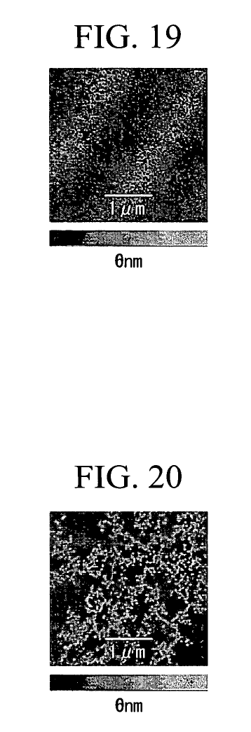

FIG. 19 shows the observation result by an atomic force microscope (SPI-3700 system made by Seiko Instruments Inc.) of a nanostructure made by spreading a single block copolymer having hydrophilic-hydrophobic segments, that is poly(α-styrene)-b-poly(ethylene oxide) (styrene unit=190, ethylene oxide unit=105), used in example 13, on the water surface.

### Comparative Example 6

FIG. 20 shows the observation result by an atomic force microscope (SPI-3700 system made by Seiko Instruments Inc.) of a nanostructure made by spreading a single block copolymer having hydrophilic-hydrophobic segments, that is poly(propylene)-b-poly(ethylene oxide) (propylene unit=202, ethylene oxide unit=105), used in example 14, on the water surface.

The nanostructure of the present invention may be used as a highly regular nanostructure as it is, or may be used as a mold for forming another highly regular nanostructure. The nanostructure of the present invention may be used as a mold to form nanowires, or the pattern formed by the hydrophilic segments and the hydrophobic segments may be used for microcontact printing, forgery prevention, nano level ruler, and the like. Moreover, it is applicable to the manufacture of magnetic recording media for hard disks having a high memory density, electrochemical cells, solar cells, photoelectric transducers, light emitting diodes, displays, optical modulators, organic FET elements, capacitors, precision filters, and the like.

What is claimed is:

1. A nanostructure comprising a mixed monomolecular film, containing
an amphipathic block copolymer which has hydrophilic segments and hydrophobic segments, and
a low molecular weight compound which is compatible with said hydrophobic segments.

2. A nanostructure according to claim 1, wherein said hydrophobic segments are two dimensionally spread in the direction of said mixed monomolecular film surface.

3. A nanostructure according to claim 1, wherein regions having said hydrophilic segments continued in the direction of said mixed monomolecular film surface, and regions having said hydrophobic segments continued in the direction of said mixed monomolecular film surface, are regularly arranged in the direction of said mixed monomolecular film surface.

4. A nanostructure according to claim 3, wherein the regions having said hydrophilic segments continued in the direction of said mixed monomolecular film surface, and the regions having said hydrophobic segments continued in the direction of said mixed monomolecular film surface, are alternately arranged to form a stripe structure.

5. A nanostructure according to claim 1, wherein said hydrophilic segments or said hydrophobic segments or both are aggregated, to form a plurality of aggregation parts.

6. A nanostructure according to claim 5, wherein said aggregation parts are formed by said hydrophilic segments or said hydrophobic segments or both being three dimensionally aggregated in the directions of the surface and thickness of said mixed monomolecular film.

7. A nanostructure according to claim 6, wherein said plurality of aggregation parts are regularly arranged in the direction of said mixed monomolecular film surface.

8. A nanostructure according to claim 7, wherein said aggregation part is dot shaped.

9. A nanostructure according to claim 1, formed on a base material comprising one or more types of materials selected from ceramics, glass, quartz, and plastics.

10. A method of manufacturing a nanostructure comprising a step of spreading a mixed solution containing an amphipathic block copolymer which has hydrophilic segments and hydrophobic segments, and a low molecular weight compound which is compatible with said hydrophobic segments, on the surface of water.

11. A method of manufacturing a nanostructure according to claim 10 comprising a step of repeating contraction and extension of said mixed monomolecular film on the water surface.

12. A method of manufacturing a nanostructure according to claim 10 comprising a step of increasing the surface pressure of the mixed monomolecular film formed by the step of spreading said mixed solution on the water surface.

13. A method of manufacturing a nanostructure according to claim 10 comprising a step of transferring the nanostructure formed on the water surface, onto a base material comprising one or more types of materials selected from ceramics, glass, quartz, and plastics.
